(19) United States
(12) Patent Application Publication
(10) Pub. No.: US 2016/0375583 A1
(43) Pub. Date: Dec. 29, 2016

(54) APPARATUS AND METHOD FOR PROVIDING ACCURACY OF ROBOT LOCATION INFORMATION BY USING SENSOR

(71) Applicant: ELECTRONICS AND TELECOMMUNICATIONS RESEARCH INSTITUTE, Daejeon (KR)

(72) Inventors: Myung Chan ROH, Daejeon (KR); Young Sook JEONG, Daejeon (KR); Beom Su SEO, Daejeon (KR); Ji Sung LEE, Daejeon (KR)

(21) Appl. No.: 15/190,064

(22) Filed: Jun. 22, 2016

(30) Foreign Application Priority Data
Jun. 23, 2015 (KR) 10-2015-0089318

(51) Int. Cl. B25J 9/16

(52) U.S. Cl. CPC B25J 9/1676; B25J 9/1694

(57) ABSTRACT

An apparatus and method for providing an accuracy of robot location information. The apparatus may include a robot location information generator and a robot location accuracy calculator, through which the accuracy of location information of itself that the robot recognizes is provided so as to prevent crashes and negligent accident, which are caused by a difference between a robot's actual location and movement path and a location and movement path of itself that the robot recognizes

### CROSS-REFERENCE TO RELATED APPLICATION(S)

This application claims the benefit under 35 U.S.C. §119(a) of Korean Patent Application No. 10-2015-0089318, filed on Jun. 23, 2015, in the Korean Intellectual Property Office, the entire disclosure of which is incorporated herein by reference for all purposes.

### BACKGROUND

1. Field

The following description relates to an apparatus for providing a robot's location, and more specifically, to an apparatus and method for providing an accuracy of robot location information that is provided to a user through sensors existing in various locations, so as to provide more accurate location information when a current location or movement path of such a robot is tracked.

2. Description of the Related Art

A recent operation method of a robot involves the following operations: under the environment, in which a map regarding an operation environment is given to a robot, the robot uses the given map according to a user's command, thereby generating a movement path from a starting point up to the destination and moving to the destination according to the generated path, thus finally moving up to the determined location on the map.

Various sensors are used to estimate such an automatically moving robot location, e.g. an auto meter, a visual auto meter, etc. as well as a global positioning system (GPS), and the location of the robot may be also estimated through the combination of the sensors therebetween.

Under this environment, most of the robots in an outdoor environment are highly dependent on the GPS, but which causes the shaded areas where GPS data reception is not seamless under the environments of the weather, the season, or the building surroundings.

Accordingly, this reason may cause a difference between a robot's actual movement path and a movement path that is generated by the robot that recognizes its location and follows the given path, thus resulting in unintentional crashes and negligent accidents.

### SUMMARY

The following disclosure relates to an apparatus and method for providing an accuracy of robot location information by using a sensor, wherein the apparatus and method provides the accuracy regarding the robot's location that the robot itself recognizes, in order to prevent crashes and negligent accidents that are caused by the difference between the robot's actual location and movement path and a location and movement path that the robot recognizes.

In one general aspect, an apparatus of providing an accuracy of robot location information by using a sensor includes: a robot location information generator to generate external location information, internal location information, and integrated location information that includes the external location information and the internal location information, wherein the external location information is generated by calculating a robot location and a sensor zero value by using one or more sensors being located outside of the robot, and modifying the robot location by using the calculated robot location and the calculated sensor zero value, and wherein the internal location information is generated by receiving map information from database, and comprises the calculated robot location on the map by using one or more sensors included in the robot; and a calculator to receive the integrated location information, match the received integrated location information to the map information, and calculate accuracy of the robot location based on a similarity of the robot location between the received integrated location information and the map information.

The robot location information generator may further include: an external location information generator to generate the external location information by performing first and second amendments of the robot location, wherein the first amendment of the robot location is performed by acquiring a distance measurement value, obtained by measuring a distance between the robot and the one or more sensors located outside of the robot, to calculate the robot location, and rotating a coordinate axis of the calculated robot location so that the coordinate axis of the calculated robot location is matched to a coordinate axis on the map, and wherein the second amendment is performed by defining an error between origin coordinates on the map and zero coordinates of the one or more sensors as a sensor zero value so as to generate the sensor zero value, and applying the sensor zero value to the robot location, where the first amendment has been performed; an internal location information generator to acquire a current location value of the robot by using the one or more sensors included in the robot, and calculate a current location of the robot on the received map information by using the acquired current location value; and an integrated location information generator to generate the integrated location information including the generated external location information and the generated internal location information.

The external location information generator may further include: a distance measurement value acquirer to acquire the distance measurement value, which is obtained by measuring a distance between the robot and the one or more sensors being located outside of the robot; a robot location calculator to calculate the robot location on the map by using a separation distance between a location of the one or more sensors on the map and the robot being spaced apart from each other by the acquired distance measurement value; a coordinate axis amender to perform a first amendment of the robot location by rotating a coordinate axis of the calculated robot location so that the coordinate axis of the calculated robot location is matched to a coordinate axis on the received map information; a sensor zero value generator to define an error between origin coordinates on the received map information and origin coordinates of the one or more sensors as a sensor zero value so as to generate the sensor zero value; and a robot location amender to perform a second amendment of the robot location by applying the generated sensor zero value to the robot location, where the first amendment has been performed, so as to generate the external location information.

The robot location calculator may calculate the robot location based on the location of each of the one or more sensors on the received map information by acquiring a plurality of distance measurement values acquired from the one or more sensors and integrating the plurality of acquired distance measurement values.

The robot location accuracy calculator may determine each coordinate on the map corresponding to external and internal location information that are included in the received integrated location information, define a coordinate on the map corresponding to the internal location information as origin coordinates, and calculate the accuracy of the robot location based on a similarity between the origin coordinates and a coordinate on the map corresponding to the external location information.

In another general aspect, a method of providing an accuracy of robot location information by using a sensor includes: generating external location information, internal location information, and integrated location information that includes the external location information and the internal location information, wherein the external location information is generated by calculating a robot location and a sensor zero value by using one or more sensors being located outside of the robot, and modifying the robot location by using the calculated robot location and the calculated sensor zero value, and wherein the internal location information is generated by receiving map information from database, and comprises the calculated robot location on the map by using one or more sensors included in the robot; and receiving the integrated location information, matching the received integrated location information to the map information, and calculating accuracy of the robot location based on a similarity of the robot location between the received integrated location information and the map information.

The generating of the integrated location information may further include: generating the external location information by performing first and second amendments of the robot location, wherein the first amendment of the robot location is performed by acquiring a distance measurement value, obtained by measuring a distance between the robot and the one or more sensors located outside of the robot, to calculate the robot location, and rotating a coordinate axis of the calculated robot location so that coordinate axis of the calculated robot location is matched to a coordinate axis on the map, and wherein the second amendment is performed by defining an error between origin coordinates on the map and zero coordinates of the one or more sensors as a sensor zero value so as to generate the sensor zero value, and applying the sensor zero value to the robot location, where the first amendment has been performed; acquiring a current location value of the robot by using the one or more sensors included in the robot, and calculating a current location of the robot on the received map information by using the acquired current location value; and generating the integrated location information including the generated external location information and the generated internal location information.

The generating of the external location information may further include: acquiring the distance measurement value, which is obtained by measuring a distance between the robot and the one or more sensors being located outside of the robot; calculating the robot location on the map by using a separation distance between a location of the one or more sensors on the map and the robot being spaced apart from each other by the acquired distance measurement value; performing a first amendment of the robot location by rotating a coordinate axis of the calculated robot location so that the coordinate axis of the calculated robot location is matched to a coordinate axis on the received map information; generating an error between origin coordinates on the received map information and origin coordinates of the one or more sensors as a sensor zero value so as to generate the sensor zero value; and performing a second amendment of the robot location by applying the generated sensor zero value to the robot location, where the first amendment has been performed, so as to generate the external location information.

The calculating of the robot location on the map may include calculating the robot location based on the location of each of the one or more sensors on the received map information by acquiring a plurality of distance measurement values acquired from the one or more sensors and by integrating the plurality of acquired distance measurement values.

The calculating of the accuracy of the robot location may include: determining each coordinate on the map corresponding to external and internal location information that are included in the received integrated location information, defining a coordinate on the map corresponding to the internal location information as origin coordinates, and calculating the accuracy of the robot location based on a similarity between the origin coordinates and a coordinate on the map corresponding to the external location information.

Other features and aspects may be apparent from the following detailed description, the drawings, and the claims.

### BRIEF DESCRIPTION OF THE DRAWINGS

FIG. 1 is a diagram illustrating an apparatus for providing an accuracy of robot location information by using a sensor according to an exemplary embodiment.

FIG. 2 is a detailed diagram illustrating a robot location information generator that is illustrated in FIG. 1.

FIG. 3 is a detailed diagram illustrating an external location information generator that is illustrated in FIG. 2.

FIG. 4 is a diagram illustrating a database format for storing integrated location information according to an exemplary embodiment.

FIG. 5 is a diagram illustrating a form of map information stored in a database according to an exemplary embodiment.

FIG. 6 is a diagram illustrating an example of generating external location information by a single external sensor.

FIG. 7 is a diagram illustrating an example of generating external location information by a plurality of external sensors.

FIG. 8 is a diagram illustrating an example of by an external sensor, measuring a distance between the sensor itself and a robot according to an exemplary embodiment.

FIG. 9 is a flowchart illustrating a method of providing an accuracy of robot location information according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Also, descriptions of well-known functions and constructions may be omitted for more clarity and conciseness, and similar reference numerals are used to refer to similar elements, features, and structures throughout the drawings and the detailed description.

In the entire disclosure, the description that one portion ‘comprises’ one element does not indicate that other elements are excluded, but it indicates other elements are further included if there are not the descriptions against the present disclosure.

Hereinafter, with reference to the following figures, described will be an apparatus and method for providing an accuracy of robot location information by using a sensor according to an exemplary embodiment.

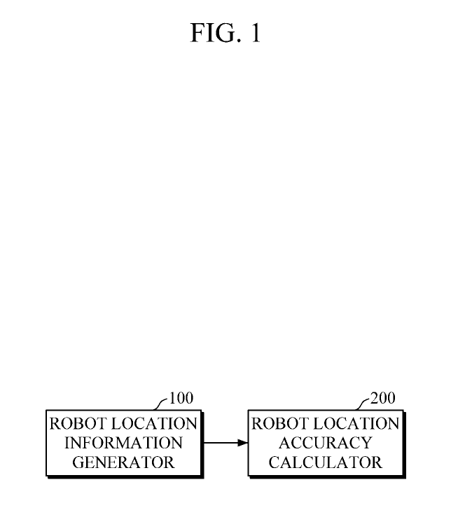

FIG. 1 is a diagram illustrating an apparatus 1000 for providing an accuracy of robot location information by using a sensor according to an exemplary embodiment.

Referring to FIG. 1, the apparatus 1000 may include a robot location information generator 100 and a robot location accuracy calculator 200.

The robot location information generator 100 may calculate the location of a robot and the sensor zero value thereof by using at least one sensor located outside of the robot, and amend the location of the robot by using the calculated location of the robot and the calculated sensor zero value, thereby generating external location information.

Also, the robot location information generator 100 may receive the map information from a database, generate internal location information, which includes the calculated location of the robot on the map by using at least one sensor included in the robot, and may also generate integrated location information that includes the generated information on the external and internal locations.

Here, the sensor is located outside including a type of a distance measuring sensor that can measure a distance between the robot and the sensor itself, or a type of a geographic position sensor, such as GPS, which is included inside the robot and can acquire the information on the robot's current location.

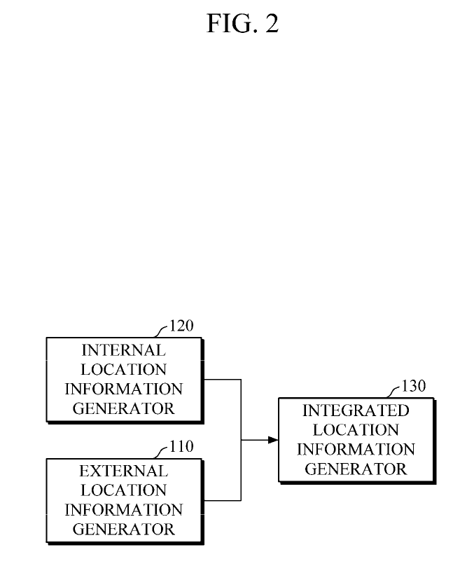

The robot location information generator 100 may be specifically described with reference to FIG. 2.

The robot location accuracy calculator 200 may match the received integrated location information and map information, respectively, and calculate the accuracy of a robot's location information based on a similarity of the robot location between the received integrated location information and the map information.

The robot location accuracy calculator 200 may determine each of the coordinates on the map, which correspond to the external location information and the internal location information that are included in the received integrated location information; define the coordinates on the map corresponding to the internal location information as origin coordinates; and calculate the accuracy of the robot's location information based on a similarity between the origin coordinates and the coordinates on the map corresponding to the external location information.

Here, the method of calculating the accuracy may involve the following operations: converting each of the X- and Y-axis values, respectively, into the number of ‘1’; calculating the coordinates on the map corresponding to the internal and external location information; based on the coordinates on the map corresponding to the internal location information, calculating the differences of the X- and Y-axis values between the coordinates on the map corresponding to the internal and external location information in accordance with the conversion of the measurable X- and Y-axis values, respectively, into the number of ‘1’; then subtracting the calculated differences from the number ‘1’, respectively; and multiplying the X- and Y-axis remainders together to calculate the accuracy.

For example, on the map where the ranges of the number of ‘10’ on the X and Y axes are measurable, the coordinates on the map corresponding to the internal location information are (4, 5), whereas the coordinates on the map corresponding to the external location information are (2, 6). In this case, the difference on the X axis is 2, whereas the one on the Y axis is 1. Then, in accordance with the conversion of the number of ‘10’ into ‘1’, the differences of the X- and Y-axis values are each converted into 0.2 and 0.1. Then, the numbers of 0.2 and 0.1 are each subtracted from the number of 1, thus acquiring the numbers of 0.8 and 0.9, which are then multiplied by each other. Accordingly, the result of 0.72 is acquired as the accuracy, thus providing a user with the information having the accuracy of 72%.

Such a method of calculating accuracy is only one exemplary embodiment, and any method can be used without any limit if it is a method of calculating accuracy by using the error between the origin coordinates and the robot's current location.

FIG. 2 is a detailed diagram illustrating a robot location information generator that is illustrated in FIG. 1.

Referring to FIG. 2, a robot location information generator 100 may include an external location information generator 110, an internal location information generator 120, and an integrated location information generator 130.

The external location information generator 110 may acquire a distance measurement value, which is obtained by measuring a distance between a robot and at least one of the sensors located outside of the robot, calculate the robot's location, and rotate the coordinate axis of the calculated robot location so that the coordinate axis of the calculated robot location is matched to the coordinate axis on the map, thus performing a first amendment of the robot's location.

In addition, the external location information generator 110 may generate the external location information by defining the error between the origin coordinates on the map and the zero coordinates on the sensor as a sensor zero value, thereby generating the sensor zero value, which is then applied to the first amendment location of the robot so as to secondly amend the robot's location.

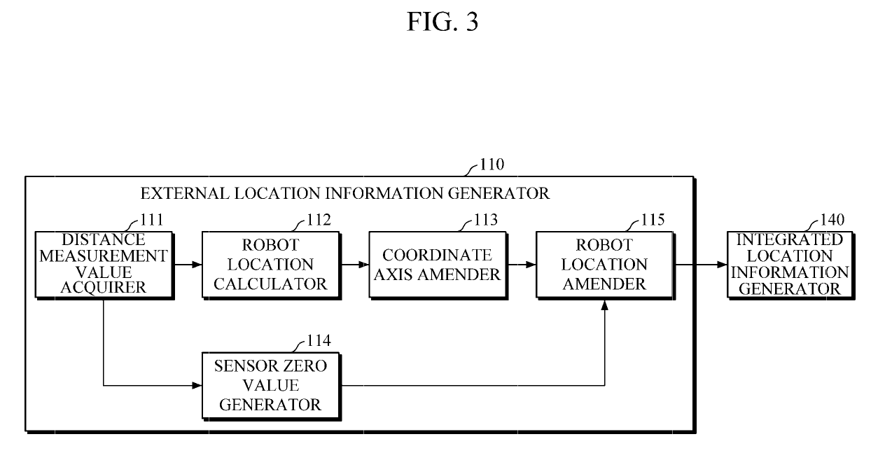

The external location information generator 110 will be described later in detail with reference to FIG. 3.

The internal location information generator 120 may acquire the robot's current location value by using the sensor that is included in the robot, and calculate the robot's current location on the received map information by using the acquired current location value.

Here, the sensor included in the robot may be a GPS to identify the robot's current location, but any sensor may be used without any limit if it can collect data regarding the current location.

According to the exemplary embodiment, the operation of calculating the current location of the robot on the received map may involve a method of matching the coordinates on the map to the current location value that is acquired from the sensor and then selecting the matched coordinates on the map as the robot's current location on the map.

The integrated location information generator 130 may generate integrated location information that includes the generated external location information and internal location information.

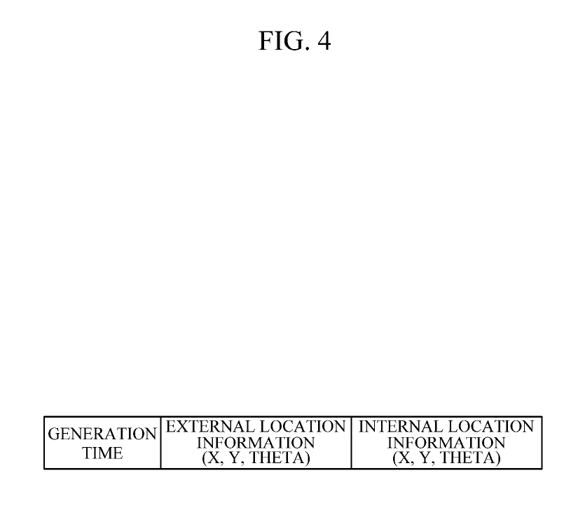

The generated integrated location information may have the form of a database illustrated in FIG. 4.

FIG. 4 is a diagram illustrating a database format for storing integrated location information according to an exemplary embodiment.

Referring to FIG. 4, for the temporal synchronization of the internal location information and the external location information when integrated location information is generated, internal location information and external location information may be stored so as to have the identical period, or stored in a single row.

Here, the internal location information and the external location information may be, respectively, stored in the form of (X, Y) or (X, Y, Theta).

Here, ‘X’ may indicate the coordinates of an X axis; ‘Y’, the coordinates of a Y axis; and ‘Theta’, the angle of a theta axis.

FIG. 3 is a detailed diagram illustrating an external location information generator 110 that is illustrated in FIG. 2.

Referring to FIG. 3, the external location information generator 110 may include a distance measurement value acquirer 111, a robot location calculator 112, a coordinate axis amender 113, a sensor zero value generator 114, and a robot location amender 115.

The distance measurement value acquirer 111 may acquire a distance measurement value, which is obtained by measuring a distance between a robot and at least one of the sensors located outside of the robot.

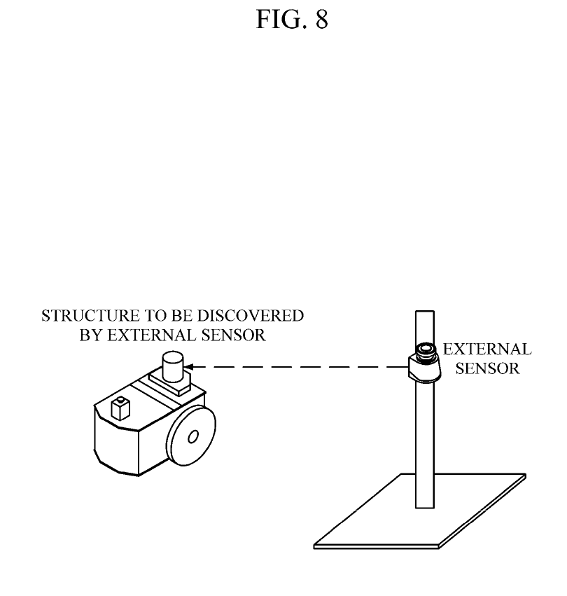

According to the exemplary embodiment, the operation of measuring a distance between the sensor and the robot may be the same as a method illustrated in FIG. 8.

FIG. 8 is a diagram illustrating an example of by an external sensor, measuring a distance between the sensor itself and a robot by an external sensor according to an exemplary embodiment.

Referring to FIGS. 3 and 8, a robot may include a cylindrical object that is attached to the upper part thereof, and the external sensor being located outside does not search for the robot body but the cylindrical object attached to the upper part of the robot body so as to measure a distance between the cylindrical object and the external sensor.

The reason why such a method is used is to measure an exact distance between the sensor and the robot by searching for the cylindrical object with no protrusion or recess.

According to the above-mentioned exemplary embodiment, the distance measurement value may refer to a separation distance between the sensor and the searched cylindrical object that is attached to the upper part of the robot.

A robot location calculator 112 in FIG. 3 may calculate the robot's location on the map by using a separation distance between the robot and the sensor on the map being spaced apart from each other by the acquired distance measurement value.

Here, according to the above-mentioned calculation method of the robot's location, the location of the sensor on the map is acquired, and then the distance measurement value is acquired from said acquired location of the sensor, which leads to the result that the robot is located on the map at a distance of the distance measurement value from the sensor.

According to the exemplary embodiment, the robot location calculator 112 may acquire a plurality of distance measurement values acquired from at least one of the sensors, and integrate the acquired distance measurement values, thereby calculating the location of the robot based on the location of each sensor on the received map information.

According to the exemplary embodiment, the integration of the acquired distance measurement values may involve the following operations: determining a robot's location to be the coordinates on the map through a sensor's location on the map acquired from each sensor and a distance measurement value measured by said sensor; determining, as the coordinates on the map, the average value that is calculated by combining said coordinates on the map for each axis and averaging the combined coordinates; and calculating the determined coordinates on the map as the current robot's location.

The coordinate axis amender 113 may perform a first amendment of the robot's location by rotating the coordinate axis of the calculated robot location so that the coordinate axis of the calculated robot location is matched to the received coordinate axis on the map.

The rotation of the coordinate axis of the robot's location may involve a method of rotating the X and Y axes of the robot's location in a predetermined direction or in both directions based on the coordinate axis of the map.

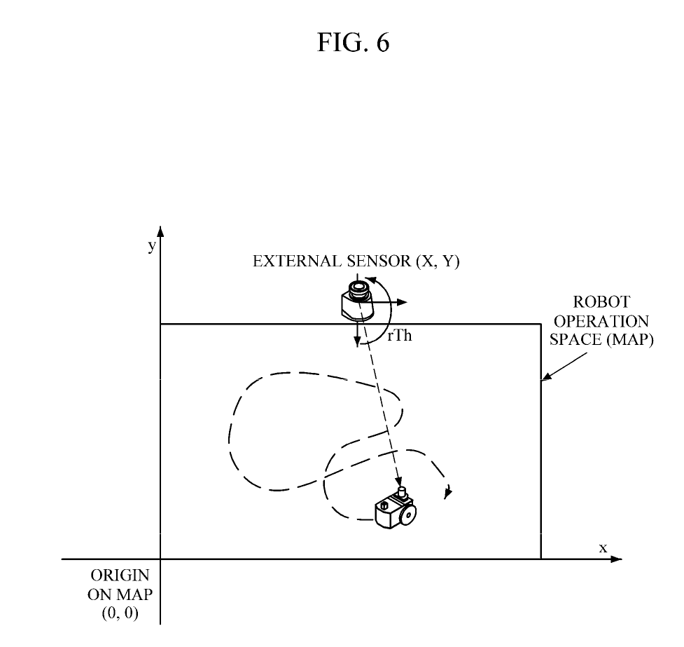

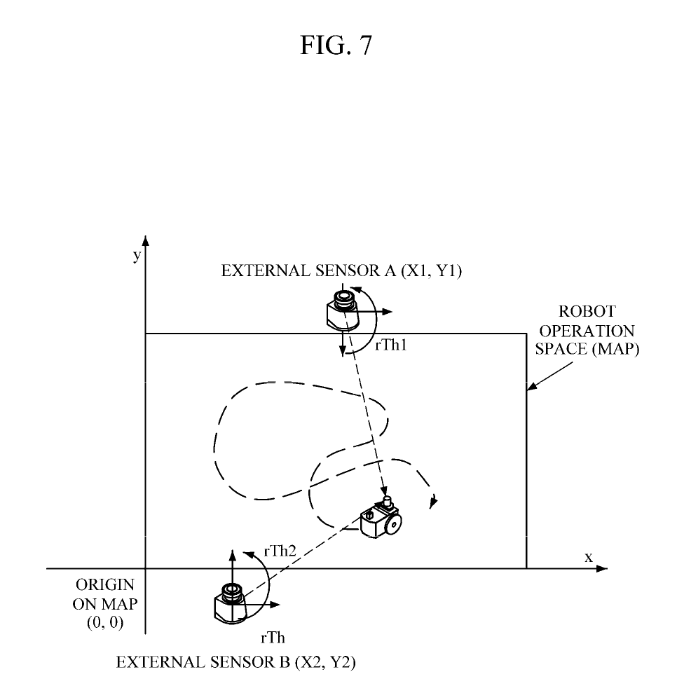

A method of amending the coordinate axis will be specifically described later with reference to FIGS. 6 and 7.

The sensor zero value generator 114 may define, as a sensor zero value, an error between the origin coordinates on the map and the X- and Y-axis values of the sensor, thereby generating the sensor zero value.

Here, the sensor zero value may indicate the X- and Y-axis difference values between the coordinate axis of the origin coordinates on the map regarding the sensor and the coordinate axis of the sensor, after the sensor located outside of the robot is located on a predetermined map so as to measure the location of a robot from the point of view of a third party.

The robot location amender 115 may apply the generated sensor zero value to the first amendment location of the robot so as to perform a second amendment of the robot's location, thus generating external location information.

The robot location amender 115 may amend the error between the coordinate axis of the origin coordinates on the map and the coordinate axis of the sensor by applying the generated sensor zero value to the calculated location of the robot on the map.

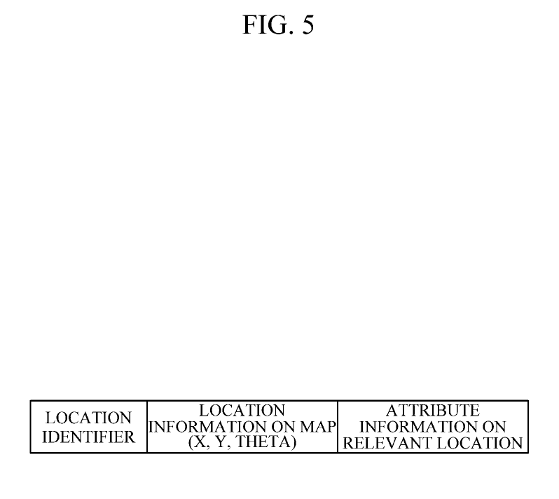

FIG. 5 is a diagram illustrating a form of map information stored in a database according to an exemplary embodiment.

Referring to FIG. 5, a format of map information stored in a database may include a location identifier that identifies a relevant location, and the location information on the map regarding the identified location, and additionally include attribute information on the relevant location.

According to the exemplary embodiment, the attribute information on the relevant location may include obstacle information, a danger alert, warning information, etc., regarding the relevant location.

FIG. 6 is a diagram illustrating an example of generating external location information by a single external sensor.

Referring to FIG. 6, in a case in which only one sensor exists outside of a robot, an apparatus 1000 for providing an accuracy of robot location information may generate a robot's external location information.

The apparatus 1000 may acquire a distance measurement value in such a manner that a sensor located outside of a robot recognizes a robot located in a robot operation space, i.e., a recognizable space on map information.

The apparatus 1000 may calculate the robot's location by using a separation distance between the sensor and the robot being spaced apart from each other by the measurement distance based on the measured location of the sensor on the map by using the acquired distance measurement value.

Here, said sensor may indicate a sensor being located outside of the robot, and may use a distance measuring sensor that can measure a distance.

After the robot's location being calculated, the robot's location may be amended by rotating the robot so as to match the coordinate axis of the calculated location of the robot to the coordinate axis on the map.

Here, since only one sensor is located outside of the robot, the robot may be rotated as much as ‘rTh’ so as to match the coordinate axis of the robot's location to the coordinate axis on the map.

According to the exemplary embodiment, the coordinate axis of the calculated robot location is rotated as much as ‘rTh’, and then the resultant location is defined as the first amendment location of the robot so as to amend the location.

According to the exemplary embodiment, the X- and Y-axis information of the sensor, received from the sensor, are matched to the origin coordinates on the map, and then the error between the origin coordinates on the map and the X- and Y-axis values of said sensor may be defined as a sensor zero value, thereby generating the sensor zero value.

In addition, the external location information may be generated through a second amendment of the robot's location to apply the generated sensor zero value to the amendment location of the robot.

FIG. 7 is a diagram illustrating an example of generating external location information by a plurality of external sensors.

FIG. 6 illustrates a single external sensor, where a coordinate axis of the position of a robot is rotated as much as ‘rTh’, and then the resultant location is defined as a first amendment location. Meanwhile, FIG. 7 illustrates an exemplary embodiment using the n number of external sensors, where a coordinate axis of the robot location is rotated as much as ‘rTh1’ ‘rTh2’, . . . , or ‘rThn’, so that the coordinate axis of the robot location is matched to the coordinate axis on the map, and the resultant location may be defined as a first amendment location, to which the current location may be amended.

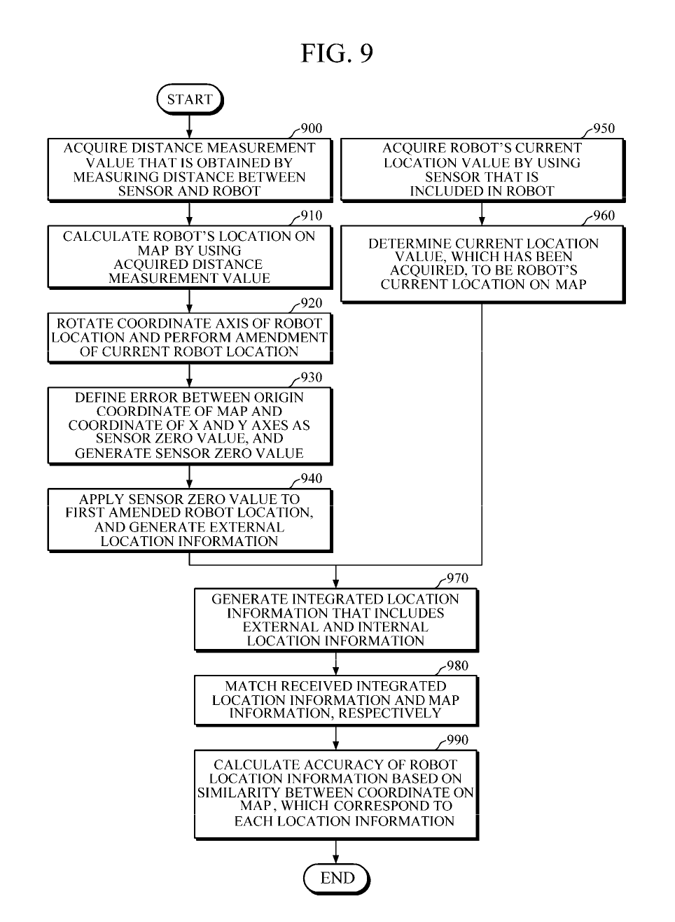

FIG. 9 is a flowchart illustrating a method of providing an accuracy of robot location information according to an exemplary embodiment.

A distance measurement value is acquired by measuring a distance between a sensor and a robot in 900.

According to the exemplary embodiment, the distance measurement value may be acquired by measuring a distance between a robot and at least one of the sensors located outside of the robot.

The robot may include a cylindrical object that is attached to the upper part thereof, and the external sensor being located outside does not search for the robot body but the cylindrical object attached to the upper part of the robot body so as to measure the distance between the cylindrical object and the external sensor.

The reason why such a method is used is to measure an exact distance between the sensor and the robot by searching for the cylindrical object with no protrusion or recess.

According to the above-mentioned exemplary embodiment, the distance measurement value may refer to a separation distance between the sensor and the searched cylindrical object that is attached to the upper part of the robot.

The robot's location on the map is calculated using the acquired distance measurement value in 910.

The robot's location on the map may be calculated the robot's location on the map by using a separation distance between the robot and the sensor on the map being spaced apart from each other by the acquired distance measurement value.

Here, according to the above-mentioned calculation method of the robot's location, the location of the sensor on the map is acquired, and then the distance measurement value is acquired from said acquired location of the sensor, which leads to the result that the robot is located on the map at a distance of the distance measurement value from the sensor.

According to the exemplary embodiment, the robot location calculator 112 may acquire a plurality of distance measurement values acquired from at least one of the sensors, and integrate the acquired distance measurement values, thereby calculating the location of the robot based on the location of each sensor on the received map information.

The integration of the acquired distance measurement values may involve the following operations: determining, as the coordinates on the map, a robot's location through a sensor's location on the map, which is acquired from each sensor, and a distance measurement value measured by said sensor; determining, as the coordinates on the map, the average value that is calculated by combining said coordinates on the map for each axis and averaging the combined coordinates; and calculating the determined coordinates on the map as the current robot's location.

The coordinate axis of the location of the robot is rotated, and then a first amendment of the current location of the robot is amended in 920.

A first amendment of the robot's location may be performed by rotating the coordinate axis of the calculated robot location so that the coordinate axis of the calculated robot location is matched to the received coordinate axis on the map.

The rotation of the coordinate axis of the robot's location may involve a method of rotating the X and Y axes of the robot's location in a predetermined direction or in both directions based on the coordinate axis of the map.

An error between the received origin coordinates on the map and the origin coordinates of said sensor may be defined as a sensor zero value, thereby generating the sensor zero value in 930.

The sensor zero value may indicate difference values of the X and Y axes between a coordinate axis of the origin coordinates on the map and the coordinate axis of the sensor that is located outside of the robot.

The generated sensor zero value is applied to the first amendment location of the robot, and then a second amendment of the robot's location is performed, thereby generating external location information in 940.

The generated sensor zero value is applied to the calculated location of the robot on the map so as to amend the error between the coordinate axis of the origin coordinates on the map and the coordinate axis of the sensor, thereby generating the external location information by using the amended location of the robot.

The robot's current location value is acquired using a sensor that is included in the robot in 950.

The sensor included in the robot may be a GPS to identify the robot's current location, but any sensor may be used without any limit if it can collect data regarding the current location.

The acquired current location value is determined to be the current location of the robot on the map in 960.

According to the exemplary embodiment, the operation of determining a current location of a robot on the map may involve a method of matching coordinates on the map to a current location value acquired from the sensor and selecting the matched coordinates on the map as a robot's current location on the map.

Integrated location information including external location information and internal location information is generated in 970.

According to the exemplary embodiment, for the temporal synchronization of the internal location information and the external location information when integrated location information is generated, internal location information and external location information may be stored to have the identical time, or stored in a single row.

Here, the internal location information and the external location information may be, respectively, stored in the form of (X, Y) or (X, Y, Theta).

Here, ‘X’ may indicate the coordinates of an X axis; ‘Y’, the coordinates of a Y axis; and ‘Theta’, the angle of a theta axis.

The received integrated location information is matched to map information, respectively, in 980.

According to the exemplary embodiment, each of the coordinates on the map may be determined, which correspond to the external location information and the internal location information that are included in the received integrated location information.

Accuracy of a robot's location information is calculated based on a similarity between the coordinates on the map, which correspond to each location information, in 990.

Here, the coordinates on the map, which correspond to each location information, may be the coordinates on the map corresponding to the internal and external location information that are included in the integrated location information.

According to the exemplary embodiment, a method of calculating accuracy of a robot location may involve the following operations: converting each of the X- and Y-axis values on the recognizable map information into the number of ‘1’; calculating each value by converting, respectively, into the number of ‘1’, the differences of the X- and Y-axis values between origin coordinates on the map and coordinates on the map corresponding to external location information; subtracting each of the calculated values from ‘1’; and acquiring accuracy by multiplying the X- and Y-axis remainders by each other.

For example, on the map where a range of the number of ‘10’ is measurable, respectively, on the X and Y axes, the coordinates on the map are (4, 5), whereas the coordinates on the map corresponding to the external location information are (2, 6), resulting in the differences of ‘2’ on the X axis and ‘1’ on the Y axis. Such X- and Y-axis differences of ‘2’ and ‘1’ become ‘0.2’ and ‘0.1’, respectively, in accordance with the conversion of the number of ‘10’ into ‘1’, which are then subtracted from ‘1’ to obtain ‘0.8’ and ‘0.9’, respectively. Then, the obtained values of ‘0.8’ and ‘0.9’ are multiplied by each other so as to acquire accuracy of ‘0.72’ indicating that the information has accuracy of ‘72%’, which is then provided to a user.

Such a method of calculating accuracy of a robot location is just one exemplary embodiment, and any method of calculating the accuracy by using the error value with origin coordinates may be used without any limit.

The exemplary embodiments according to the present invention are not implemented only through the above-mentioned apparatuses and/or methods. In addition, the exemplary embodiments of the present invention are specifically described above, but the scope of the invention is not limited thereto, and various changes, modifications, and equivalents are within the scope of claims, which are performed by those skilled in the art by using the fundamental concepts of the present invention defined in the following claims.

What is claimed is:

1. An apparatus of providing an accuracy of robot location information by using a sensor, the apparatus comprising:
a robot location information generator configured to generate external location information, internal location information, and integrated location information that includes the external location information and the internal location information,
wherein the external location information is generated by calculating a robot location and a sensor zero value by using one or more sensors being located outside of the robot, and modifying the robot location by using the calculated robot location and the calculated sensor zero value, and
wherein the internal location information is generated by receiving map information from database, and comprises the calculated robot location on the map by using one or more sensors included in the robot; and
a calculator configured to receive the integrated location information, match the received integrated location information to the map information, and calculate accuracy of the robot location based on a similarity of the robot location between the received integrated location information and the map information.

2. The apparatus of claim 1, wherein the robot location information generator further comprises:
an external location information generator configured to generate the external location information by performing first and second amendments of the robot location,
wherein the first amendment of the robot location is performed by acquiring a distance measurement value, obtained by measuring a distance between the robot and the one or more sensors located outside of the robot, to calculate the robot location, and rotating a coordinate axis of the calculated robot location so that the coordinate axis of the calculated robot location is matched to a coordinate axis on the map, and
wherein the second amendment is performed by defining an error between origin coordinates on the map and zero coordinates of the one or more sensors as a sensor zero value so as to generate the sensor zero value, and applying the sensor zero value to the robot location, where the first amendment has been performed;
an internal location information generator configured to acquire a current location value of the robot by using the one or more sensors included in the robot, and calculate a current location of the robot on the received map information by using the acquired current location value; and
an integrated location information generator configured to generate the integrated location information including the generated external location information and the generated internal location information.

3. The apparatus of claim 2, wherein the external location information generator further comprises:
a distance measurement value acquirer configured to acquire the distance measurement value, which is obtained by measuring a distance between the robot and the one or more sensors being located outside of the robot;
a robot location calculator configured to calculate the robot location on the map by using a separation distance between a location of the one or more sensors on the map and the robot being spaced apart from each other by the acquired distance measurement value;
a coordinate axis amender configured to perform a first amendment of the robot location by rotating a coordinate axis of the calculated robot location so that the coordinate axis of the calculated robot location is matched to a coordinate axis on the received map information;
a sensor zero value generator configured to define an error between origin coordinates on the received map information and origin coordinates of the one or more sensors as a sensor zero value so as to generate the sensor zero value; and
a robot location amender configured to perform a second amendment of the robot location by applying the generated sensor zero value to the robot location, where the first amendment has been performed, so as to generate the external location information.

4. The apparatus of claim 3, wherein the robot location calculator is configured to calculate the robot location based on the location of each of the one or more sensors on the received map information by acquiring a plurality of distance measurement values acquired from the one or more sensors and integrating the plurality of acquired distance measurement values.

5. The apparatus of claim 1, wherein the robot location accuracy calculator is configured to determine each coordinate on the map corresponding to external and internal location information that are included in the received integrated location information, define a coordinate on the map corresponding to the internal location information as origin coordinates, and calculate the accuracy of the robot location based on a similarity between the origin coordinates and a coordinate on the map corresponding to the external location information.

6. A method of providing an accuracy of robot location information by using a sensor, the method comprising:
generating external location information, internal location information, and integrated location information that includes the external location information and the internal location information,
wherein the external location information is generated by calculating a robot location and a sensor zero value by using one or more sensors being located outside of the robot, and modifying the robot location by using the calculated robot location and the calculated sensor zero value, and
wherein the internal location information is generated by receiving map information from database, and comprises the calculated robot location on the map by using one or more sensors included in the robot; and
receiving the integrated location information, matching the received integrated location information to the map information, and calculating accuracy of the robot location based on a similarity of the robot location between the received integrated location information and the map information.

7. The method of claim 6, wherein the generating of the integrated location information further comprises:
generating the external location information by performing first and second amendments of the robot location,
wherein the first amendment of the robot location is performed by acquiring a distance measurement value, obtained by measuring a distance between the robot and the one or more sensors located outside of the robot, to calculate the robot location, and rotating a coordinate axis of the calculated robot location so that coordinate axis of the calculated robot location is matched to a coordinate axis on the map, and
wherein the second amendment is performed by defining an error between origin coordinates on the map and zero coordinates of the one or more sensors as a sensor zero value so as to generate the sensor zero value, and applying the sensor zero value to the robot location, where the first amendment has been performed;
acquiring a current location value of the robot by using the one or more sensors included in the robot, and calculating a current location of the robot on the received map information by using the acquired current location value; and
generating the integrated location information including the generated external location information and the generated internal location information.

8. The method of claim 7, wherein the generating of the external location information further comprises:
acquiring the distance measurement value, which is obtained by measuring a distance between the robot and the one or more sensors being located outside of the robot;
calculating the robot location on the map by using a separation distance between a location of the one or more sensors on the map and the robot being spaced apart from each other by the acquired distance measurement value;
performing a first amendment of the robot location by rotating a coordinate axis of the calculated robot location so that the coordinate axis of the calculated robot location is matched to a coordinate axis on the received map information;
generating an error between origin coordinates on the received map information and origin coordinates of the one or more sensors as a sensor zero value so as to generate the sensor zero value; and
performing a second amendment of the robot location by applying the generated sensor zero value to the robot location, where the first amendment has been performed, so as to generate the external location information.

9. The method of claim 8, wherein the calculating of the robot location on the map comprises:
calculating the robot location based on the location of each of the one or more sensors on the received map information by acquiring a plurality of distance measurement values acquired from the one or more sensors and by integrating the plurality of acquired distance measurement values.

10. The method of claim 6, wherein the calculating of the accuracy of the robot location comprises:
determining each coordinate on the map corresponding to external and internal location information that are included in the received integrated location information, defining a coordinate on the map corresponding to the internal location information as origin coordinates, and calculating the accuracy of the robot location based on a similarity between the origin coordinates and a coordinate on the map corresponding to the external location information.
